(19) United States
(12) Patent Application Publication
(10) Pub. No.: US 2010/0006179 A1
(43) Pub. Date: Jan. 14, 2010

(54) Combined base assembly and granite jointer table for hand jointer

(76) Inventor: Lee-Cheng Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/170,478

(22) Filed: Jul. 10, 2008

(51) Int. Cl. B27C 1/00

(52) U.S. Cl. 144/129

(57) ABSTRACT

A hand jointer comprises a plane means, a base assembly including two supports spaced from each other and at least one coupled member connected the supports to each other, with the plane means installed on the supports, at least one connected portion disposed on each support of the base assembly for coupling the base assembly to the plane means and a granite jointer table installed on the at least one coupled member.

### BACKGROUND OF THE INVENTION

1. Field of the Invention

The present invention relates to a combined base assembly and a granite jointer for a hand jointer.

2. Description of the Related Art

A hand jointer is one of a kind of wood making machine tools. The hand jointer allows a user to form a precise angle between two surfaces on a workpiece, usually a wood board to be used in a final product such as furniture, cabinetry, and the like.

Referring to Taiwan Patent No M253474, a conventional hand jointer includes a base 20, four support legs 21 installed on four corners of the base 20, an engine frame 30, four collars 31 defined on the periphery of the engine frame 30 and respectively mounted on the support legs 21, two lifters 22 respectively engaged with two sides of the engine frame 30, and a rotation grip 23 for lifting/lowering the engine frame 30. A locking device is disposed on the engine frame 30.

However, the base 20 of the work bench is usually made of metal material like die-cast aluminum and so on.

No matter which metal material the base 20 is made of, the shortcomings of the metal base 20 are instability and properties of wear resistance. Therefore, this kind of base 20 is easy to be influenced via temperature and humidity. It causes higher cost of maintenance.

Moreover, a jointer table is usually manufactured to be in form of a thick board with huge length and depth and integrally combined with the base 20 of the conventional hand jointer. Because the material and the volume of the jointer table, it is not easy to keep the surface of the jointer table being level for placement of wood-board workpieces during operation. In addition, suppose the surface of the jointer table should become not level, the jointer table is needed to return the level condition by CNC milling machines.

The present invention is therefore intended to obviate or at least alleviate the problems encountered in prior art.

### SUMMARY OF THE INVENTION

It is therefore an object of the present invention to provide a combined base assembly for a hand jointer that includes two supports and several coupled members which couple the supports to each other and provide for a jointer table being disposed thereon.

An advantage to the present invention is that parts of the base assembly of the hand jointer can be manufactured individually as to achieve efficiency increase.

Another advantage to the present invention is that the base assembly and the granite jointer table are enable to disassemble as to minimize its transportation cost.

Yet another advantage to the present invention is that numbers of connected portions are provided on the base assembly for quick installation of a plane means to the base assembly.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the preferred embodiment referring to the drawings.

FIG. 1 is a perspective view of a hand jointer with a combined base assembly and a granite jointer table according to the preferred embodiment of the present invention.

FIG. 2 is an exploded view of the hand jointer shown in FIG. 1.

FIG. 3 is a cross-sectional view of the hand jointer shown in FIG. 1.

### DETAILED DESCRIPTION OF THE PREFERRED EMBODIMENT

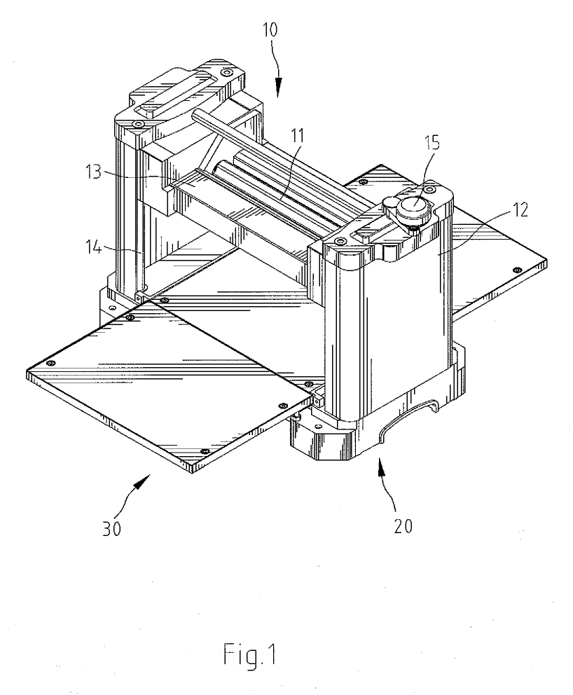

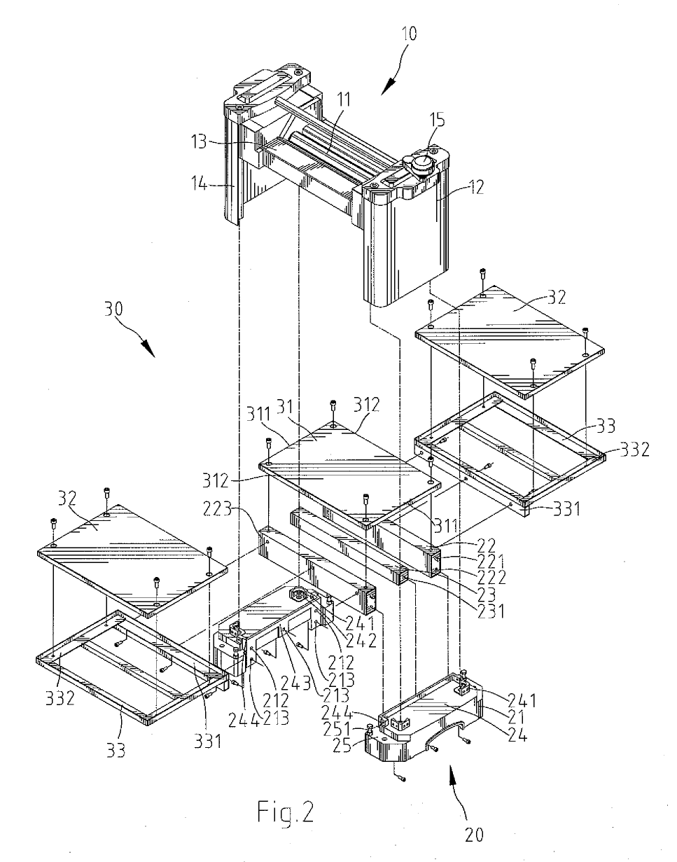

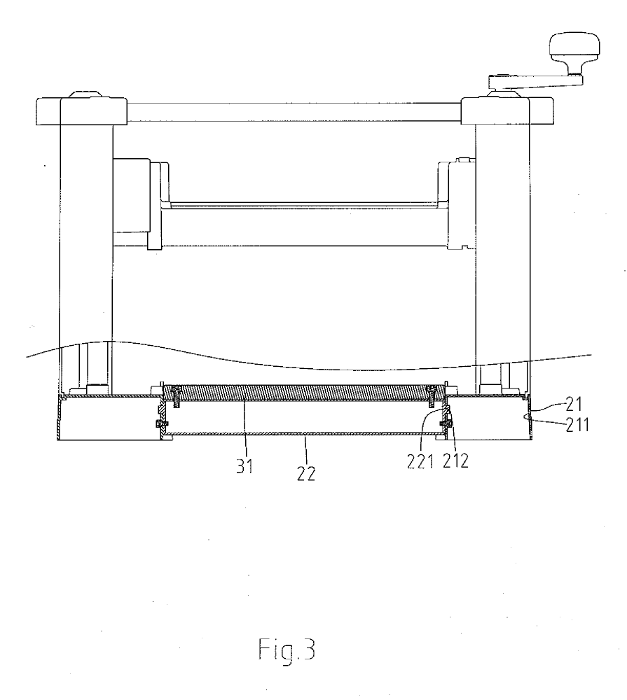

Referring to FIGS. 1 through 3, a hand jointer includes a plane means 10, a combined base assembly 20 and a granite jointer table 30. The plane means 10 and the granite jointer table 30 are disposed on the base assembly 20, respectively. The granite jointer table 30 is adapted to contact with a side of a workpiece that is prepared for process via a plane 11 of the plane means 10.

The plane means 10 further includes two sidewalls 12, a lift platform 13 installed between the sidewalls 12 and four support legs 14 respectively fixed on two ends of each sidewall 12. The plane 11 is disposed on the lift platform 13 whose four corners are provided to be slidably mounted on the support legs 14, respectively. A rotational grip 15 is operated to adjust the lift platform 13 to lift/lower relative to the support legs 14 for planing.

The base assembly 20 includes two supports 21 spaced from each other and installed on the bottom of the sidewalls 12, respectively, and two first coupled members 22 and a second coupled member 23 provided to connect the supports 21 to each other. The granite jointer table 30 is disposed onto the first and second coupled members 22 and 23.

Each support 21 includes a space 211 and is open to the bottom thereof so that each support 21 is hollow. A sustain surface 24 is formed on the top of each support 21 and receives the bottom of each sidewall 12. Two stretched portions 25 extends from two ends of each support 21, and the distance between each sustain surface 24 and the bottom of the support is larger than the distance between each stretched portion 25 and the bottom of the support. Two connected portions 241 are provided on each sustain surface 24 and respectively correspond to the corners of each sidewall 12 as to securely engage the plane means 10 with the supports 21 of the base assembly 20. In this embodiment, each connected portion 241 is preferably L-shaped. A through-hole 242 is provided on each connected portion 241 and pierces through the related support 21 as to engage the support legs 14 with the connected portions 241, respectively. A side of each support 21 that is abutted with the first and second coupled members 22 and 23 defines an abutted surface 243. A limited portion 244 is provided on the border between each stretched portion 25 and the related sustain surface 24.

Numbers of fixed holes 212 and thread holes 213 are formed on each abutted surface 243. A fixed portion 221 protrudes from each end of the first coupled member 22 and coincides with and is inserted into one of the fixed holes 212. Thread holes 222 and 231 are respectively formed on each end of the first and second coupled members 22 and 23 and coincide with the thread holes 213. Numbers of bolts (not numbered) are provided to engage each of the thread holes 222 and 231 with the related thread hole 213.

The granite jointer table 30 includes a granite main plate 31 and two granite auxiliary plates 32, with the main plate 31 and the auxiliary plates 32 all made of granite and preferably in form of a rectangular shape. Granite is a common and widely occurring type of intrusive, felsic, igneous rock. Granite has a medium to coarse texture, occasionally with some individual crystals larger than the groundmass forming a rock known as porphyry. Granite is nearly always massive (lacking internal structures), hard and tough, and therefore it has gained widespread use as a construction stone. Once granite is manufactured to a finished product, the granite product would not be easily deformed or depressed. The average density of granite is 2.75 g/cm³.

Granite is a highly durable siliceous stone. Compared to marble, it is more resistant to the acids found in lemons, vinegars, and cleaning products and usually will not etch. It is an easy stone to live with.

Granite characteristics make this stone virtually scratch proof. It will not scratch even when directly cut on. Things such as keys, coins, utensils, and appliances won't scratch it either.

Granite will actually dull your knives. Little slivers of the knife can become embedded in your stone. This is very noticeable with the darker stones so make a note if you are using your stone as a cutting board.

The characteristics of granite also make this stone heat resistant. It can withstand heat up to 1200 degrees Fahrenheit. Users won't have to worry about any burn or char marks.

The main plate 31 has two first sides 311 opposite to each and two second sides 312 opposite to each other, with the first sides 311 respectively abutted with the abutted surfaces 243, with the second sides 312 respectively abutted with the auxiliary plates 32. The main plate 31 is disposed on the first and second coupled members 22 and 23 and whose four corners (not numbered) couple to the top of two ends of each first coupled member 22 via four bolts (not numbered).

Two support frames 33 are installed to the first coupled members 22, respectively, and each support frame 33 includes a coupled portion 331 that couples to a side 223 of each first coupled member 22 which is opposite to the second coupled member 23 and two support portions 332 that are defined two sides thereof for supporting the related auxiliary plate 32. Several holes (not numbered) are formed on each side 223 and engaged with each support frame 33 via several bolts (not numbered). The auxiliary plates 32 are respectively disposed on the support frames 33, and four corners (not numbered) of each auxiliary plate 32 couple to the support portions 332 of each support frame 33 via four bolts (not numbered). A protrusion 251 is provided on each stretched portion 25 and abutted against the related support frame 33 for preventing the support frames 33 swaying. Moreover, the limited portions 244 provide the support frames 33 are further secured between the supports 21.

The support frames 33 are made by punching, and because of the small volume of each support frame 33, the manufacturing of support frames 33 is low cost.

What is claimed is:

1. A hand jointer comprising:
a plane means;
a base assembly including two supports spaced from each other and at least one coupled member connected the supports to each other, with the plane means installed on the supports; and
a granite jointer table installed on the at least one coupled member.

2. The hand jointer as claimed in claim 1, further comprising two first coupled members and a second coupled member for coupling the supports to each other, with the granite jointer table disposed on the first and the second coupled members and fixed to the top of the first coupled members.

3. The hand jointer as claimed in claim 2, with two ends of each first coupled member having at least one fixed portion and at least one thread hole, with two ends of the second coupled member having at least one thread hole, with a plurality of fixed holes and thread holes formed on a side of each support that is abutted with the first and the second coupled members, with the fixed holes of the supports corresponding to the at least one fixed portion of the first coupled member, with the thread holes of the supports corresponding to the at least one thread holes of the first and second coupled members, respectively.

4. The hand jointer as claimed in claim 1, further comprising at least one connected portion disposed on each support of the base assembly for coupling the base assembly to the plane means.

5. The hand jointer as claimed in claim 4, with each connected portion defining a through-hole, with the plane means including two sidewalls installed on the supports respectively and two support legs provided on each sidewall and corresponding to the through-holes as to fix the plane means to the base assembly.

6. The hand jointer as claimed in claim 5, with each support of the base assembly having a space and open to the bottom thereof.

7. The hand jointer as claimed in claim 4, with each support including a sustain surface formed thereon, with the at least one connected portion provided on the sustain surfaces.

8. The hand jointer as claimed in claim 7, further comprising two stretched portions extending from two ends of each support, and the distance between each sustain surface and the bottom of the support is larger than the distance between each stretched portion and the bottom of the support.

9. The hand jointer as claimed in claim 4, with each first coupled member having a side opposite to the second coupled member, with the granite jointer table including a granite main plate, at least one granite auxiliary plate and at least one support frame, with the granite main plate disposed on the first and second coupled members, with the at least one support frame coupled to the side of each first coupled member, with the at least one granite auxiliary plate installed on the related support frame.

10. The hand jointer as claimed in claim 9, with the granite jointer table including two granite auxiliary plates and two support frames, with the support frames respectively installed onto the sides of the first coupled members.
